(19) United States
(12) Patent Application Publication
(10) Pub. No.: US 2025/0244775 A1
(43) Pub. Date: Jul. 31, 2025

(54) METHOD OF CONTROLLING AN OFF-ROAD VEHICLE RELATIVE TO A SECONDARY OFF-ROAD VEHICLE

(71) Applicant: BOMBARDIER RECREATIONAL PRODUCTS INC., Valcourt (CA)

(72) Inventors: Maxime BOISVERT, Sherbrooke (CA); Maxime DESJARDINS-GOULET, Stoke (CA); Antoine COTE, Sherbrooke (CA); Simon LAPERLE, Sherbrooke (CA); Tyler MONTCALM, Sherbrooke (CA); El Mehdi MOJAB, Vaudreuil-Dorion (CA)

(21) Appl. No.: 19/033,873

(22) Filed: Jan. 22, 2025

Related U.S. Application Data
(60) Provisional application No. 63/626,186, filed on Jan. 29, 2024.

(51) Int. Cl. G05D 1/693; G05D 1/82; G05D 107/00; G05D 107/20; G05D 107/30

(52) U.S. Cl. CPC G05D 1/693; G05D 1/82; G05D 2107/20; G05D 2107/25; G05D 2107/30

(57) ABSTRACT

A method for controlling an off-road vehicle relative to a secondary off-road vehicle. The method, executed by a processor of the vehicle, includes the steps of receiving an input from the secondary off-road vehicle, determining a predicted trajectory path of the vehicle; determining a trajectory position of the vehicle, the trajectory position corresponding to a point of interest related to a distance between the vehicle and the secondary off-road vehicle on the predicted trajectory path; determining a separation distance between the secondary off-road vehicle and the trajectory position; and in response to the separation distance being less than a distance threshold, controlling a speed of the vehicle.

### CROSS-REFERENCE

The present application claims priority to U.S. Provisional Patent Application No. 63/626,186, filed on Jan. 29, 2024, the entirety of which is incorporated herein by reference.

### TECHNICAL FIELD

The present technology relates to a method of controlling an off-road vehicle, and particularly a method for controlling a speed of the off-road vehicle relative to a secondary off-road vehicle.

### BACKGROUND

Avoidance technologies have become increasingly important in modern road vehicles. However, off-road vehicles such as all-terrain vehicles and watercrafts operate in off-road environments and around other off-road vehicles. Off-road environments lack the order and predictability associated with on-road environments which makes current on-road avoidance technologies inadequate for off-road vehicles. Thus, there is an increased emphasis on the importance of avoidance systems and methods for off-road vehicles.

Therefore, there is a desire for developing a method to control the vehicle that can overcome at least some of the above-described drawbacks.

### SUMMARY

It is an object of the present technology to ameliorate at least some of the inconveniences present in the prior art.

According to one aspect of the present technology, there is provided a method for controlling an off-road vehicle relative to a secondary off-road vehicle, the method being executed by a processor of the vehicle. The method includes receiving an input from the secondary off-road vehicle, the input being indicative of a position of the secondary off-road vehicle; determining a predicted trajectory path of the vehicle; determining a trajectory position of the vehicle, the trajectory position corresponding to a point of interest on the predicted trajectory path selected based on at least a distance between the vehicle and the position of the secondary off-road vehicle; determining a separation distance between the trajectory position of the vehicle and the position of the secondary off-road vehicle; and in response to the separation distance being less than a distance threshold, controlling a speed of the vehicle.

In some embodiments, controlling the speed of the vehicle includes limiting the speed of the vehicle.

In some embodiments, limiting the speed of the vehicle increases as the separation distance decreases.

In some embodiments, controlling the speed of the vehicle includes increasing the speed of the vehicle.

In some embodiments, the method further includes determining an arrival time until the vehicle reaches the trajectory position, and wherein controlling the speed of the vehicle is based, at least in part, on the arrival time.

In some embodiments, controlling the speed of the vehicle includes limiting a speed of the vehicle, and in response to a decrease of the arrival time, increasing limitation of the speed of the vehicle.

In some embodiments, receiving the input of the secondary off-road vehicle includes receiving a signal compatible with C-V2X communication.

In some embodiments, the vehicle further includes a camera and wherein receiving the input of the secondary off-road vehicle includes receiving an input from the camera.

In some embodiments, receiving the input of the secondary off-road vehicle further includes receiving at least one of: a speed of the secondary off-road vehicle, an acceleration of the secondary off-road vehicle, an orientation of the secondary off-road vehicle, and a steering angle of the secondary off-road vehicle.

In some embodiments, the distance between the vehicle and the position of the secondary off-road vehicle corresponds to a shortest distance between the vehicle and the position of the secondary off-road vehicle along the predicted trajectory path.

In some embodiments, determining the predicted trajectory path, determining the trajectory position, and determining the separation distance are recursive and occurs at at least one sampling rate.

In some embodiments, the method further includes increasing the at least one sampling rate as the separation distance decreases.

In some embodiments, determining a trajectory speed of the vehicle at the trajectory position; and in response to the trajectory speed being greater than a speed threshold, controlling the speed of the vehicle.

In some embodiments, receiving a signal from at least one sensor, the vehicle including the at least one sensor for detecting at least one of: a current orientation of the vehicle, the speed of the vehicle, an acceleration of the vehicle, a steering angle of the vehicle, a user input, and a current position of the vehicle; and determining the trajectory speed of the vehicle includes using a prediction algorithm and the signal from the at least one sensor to determine the trajectory speed.

In some embodiments, receiving the signal from the at least one sensor includes receiving a signal from at least one of: an accelerometer, a gyroscope, a magnetometer, a steering angle sensor, a user input sensor, and a global navigation satellite system.

In some embodiments, using the prediction algorithm includes using a Kalman filter algorithm.

In some embodiments, receiving a signal from at least one sensor, the vehicle including the at least one sensor for detecting at least one of: a current orientation of the vehicle, the speed of the vehicle, an acceleration of the vehicle, a steering angle, a user input, and a current position of the vehicle; and determining the predicted trajectory path of the vehicle includes using a prediction algorithm and the signal from the at least one sensor.

In some embodiments, determining the predicted trajectory path of the vehicle includes determining at least one of: a magnitude of steering the vehicle, a rate of change of steering the vehicle, a magnitude of throttle, a rate of change of throttle, a magnitude of braking, and a rate of change of braking.

In some embodiments, receiving the signal from the at least one sensor includes receiving the signal from at least one of: an accelerometer, a gyroscope, a magnetometer, a steering angle sensor, a user input sensor, and a global positioning system.

In some embodiments, using the prediction algorithm includes using a Kalman filter.

In some embodiments, determining an arrival time until the vehicle reaches the trajectory position; and determining a probability of interaction, the probability of interaction being determined at least in part by the separation distance and an accuracy of the at least one sensor; and controlling the speed of the vehicle is based, at least in part, on the arrival time and the probability of interaction.

In some embodiments, the vehicle is a personal watercraft; and controlling the speed of the vehicle includes controlling the speed of the personal watercraft.

In some embodiments, controlling the speed of the personal watercraft includes managing the speed of a jet pump.

In some embodiments, the method further includes triggering at least one of a visual and an audible alert to a driver of the vehicle to indicate that the vehicle speed is being controlled.

According to one aspect of the present technology, there is provided a method for controlling an off-road vehicle relative to a secondary off-road vehicle, the method being executed by a processor of the vehicle. The method includes receiving an input from a secondary off-road vehicle; determining a predicted trajectory path of the vehicle; determining a secondary off-road vehicle predicted trajectory path; determining a trajectory position of the vehicle, the trajectory position corresponding to a point of interest on the predicted trajectory path selected based on a distance between the predicted trajectory path and the secondary off-road vehicle predicted trajectory path; determining a separation distance between the trajectory position and the secondary off-road vehicle predicted trajectory path; and in response to the separation distance being less than a distance threshold, controlling a speed of the vehicle.

In some embodiments, receiving the input from the secondary off-road vehicle includes receiving at least one signal indicative of at least one of: a current orientation of the secondary off-road vehicle, a speed of the secondary off-road vehicle, an acceleration of the secondary off-road vehicle, a steering angle of the secondary off-road vehicle, a user input of the secondary off-road vehicle, and a position of the secondary off-road vehicle.

In some embodiments, determining the secondary off-road vehicle predicted trajectory path includes using a prediction algorithm and the at least one signal.

In some embodiments, using the prediction algorithm includes using a Kalman filter.

In some embodiments, the distance between the predicted trajectory path and the secondary off-road vehicle predicted trajectory path is a shortest distance between the predicted trajectory path and the secondary off-road vehicle predicted trajectory path.

In some embodiments, controlling the speed of the vehicle includes limiting a speed of the vehicle.

In some embodiments, limiting the speed of the vehicle increases as the separation distance decreases.

In some embodiments, controlling the speed of the vehicle includes increasing a speed of the vehicle.

In some embodiments, the method further includes determining an arrival time until the vehicle reaches the trajectory position, and wherein controlling the speed of the vehicle is based, at least in part, on the arrival time.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example “A and/or B” is to be taken as specific disclosure of each of (i) A, (ii) B and (iii) A and B, just as if each is set out individually herein.

For purposes of the present application, terms related to spatial orientation such as forward, rearward, upward, downward, left and right, should be understood by a driver of a vehicle in a neutral position. For example, a watercraft in which the watercraft is in a neutral trim position with the driver in a driving position.

As used herein, the functions of a “processor”, may be provided through the use of dedicated hardware as well as hardware capable of executing software in association with appropriate software, including for instance hardware of the vehicle. When provided by the processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a flow diagram depicting a method for controlling an off-road vehicle, in accordance with an embodiment of the present technology;

FIG. 2 is a schematic top plan view of an off-road vehicle approaching a secondary off-road vehicle in an application of the method of FIG. 1;

FIG. 3 is a flow diagram depicting a method for controlling a vehicle, in accordance with another embodiment of the present technology;

FIG. 4 is a flow diagram depicting a method for controlling a vehicle, in accordance with yet another embodiment of the present technology;

FIG. 5 is a schematic top plan view of an off-road vehicle approaching a secondary off-road vehicle, in an application of the method of FIG. 4.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, “having”, “containing”, “involving” and variations thereof herein, is meant to encompass the items listed thereafter as well as, optionally, additional items. In the following description, the same numerical references refer to similar elements.

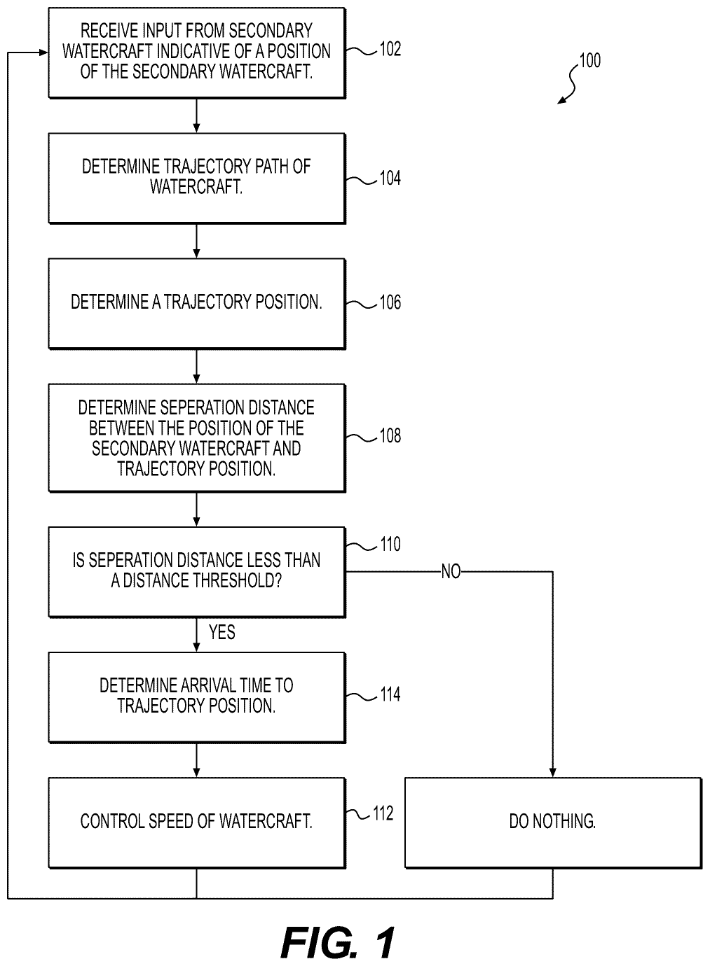

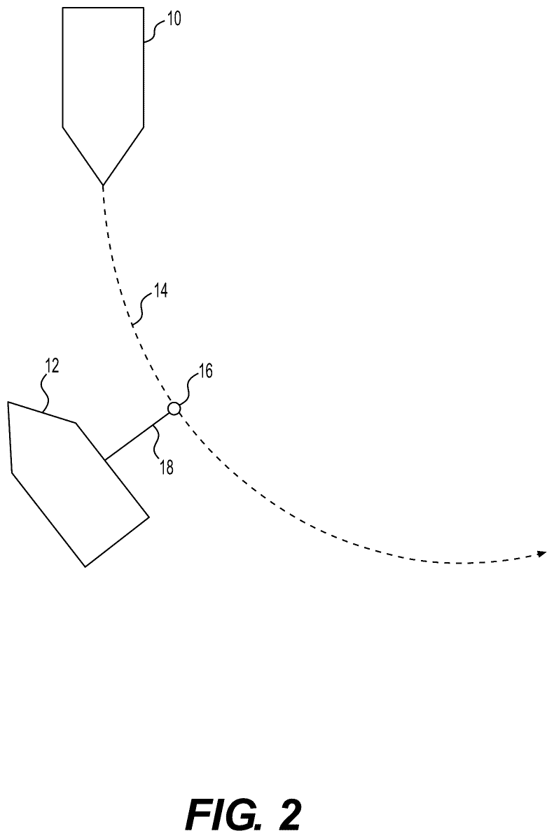

With reference to FIGS. 1 and 2, a method 100 of controlling an off-road vehicle 10 relative to a secondary off-road vehicle 12 will be described. In the presently described embodiment, the off-road vehicle 10 is a personal watercraft 10 which is approaching a secondary personal watercraft 12. It is contemplated that, in alternative embodiments, the vehicle 10 may be any off-road vehicle, such as an all-terrain vehicle (ATV), a snow mobile, or a side-by-side vehicle (SSV), and the secondary vehicle 12 may be any off-road vehicle, such as an all-terrain vehicle (ATV), a snow mobile, or a side-by-side vehicle (SSV).

FIG. 1 depicts a flow diagram illustrating the method 100 of controlling the watercraft 10. In this embodiment, the method 100 is executed on a processor which is part of the watercraft 10. The processor is configured to receive information regarding the watercraft 10, such as position, orientation, and/or speed of the watercraft 10, as well as information regarding the secondary watercraft 12, which will be described in further detail below.

The method 100 begins, at step 102, with receiving an input from the secondary watercraft 12 indicative of a position of the secondary watercraft 12. In certain embodiments, the input may additionally include at least one of: a speed of the secondary watercraft 12, an acceleration of the secondary watercraft 12, an orientation of the secondary watercraft 12, a user input of the secondary watercraft 12, and/or a steering angle of the secondary watercraft 12. It is contemplated that, in some embodiments, the watercraft 10 could include a camera to detect behavior (i.e., speed, acceleration, orientation, and/or position) of the secondary watercraft 12, and the input is received from the camera of the watercraft 10. It is further contemplated that, in alternative embodiments, the respective watercrafts 10, 12 could be configured to communicate wirelessly via cellular vehicle-to-everything (C-V2X) communication and receiving the input from the secondary watercraft 12 involves receiving a signal compatible with C-V2X communication.

The method 100 continues, at step 104, with determining a predicted trajectory path 14 of the watercraft 10. In this embodiment, the trajectory path 14 is, at least in part, determined by a current state of the watercraft 10 (such as current orientation, speed, and/or position, and/or a user input such as current application of throttle by the driver), as well as determined by a prediction algorithm (described in additional detail below).

The current state of the watercraft 10 may be obtained by sensors positioned on the watercraft 10 and communicatively connected to the processor, such that the processor receives signals from the sensors. In some embodiments, the sensors may include an accelerometer, a gyroscope, a magnetometer, a steering angle sensor, a user input sensor (e.g., to measure how much the driver is depressing a throttle or accelerator, etc.), and a global navigation satellite system (GNSS), for example the global positioning system (GPS). However, it is appreciated that other sensors may be implemented and communicatively connected to the processor to provide signals regarding the current state of the watercraft 10.

In certain embodiments, the trajectory path 14 is further predicted, at least in part, by characteristics of the watercraft 10. Specifically, characteristics related to the handling of the watercraft 10 including but not limited to speed and/or acceleration. For example, how tight the watercraft 10 can turn, how much negative acceleration the watercraft 10 may experience (if there is no accelerator input), how much speed the watercraft 10 can gain over a distance during maximum acceleration, how much acceleration the watercraft 10 may experience when turning at certain angles, etc. In some instances, these characteristics may be predetermined through testing and/or simulations.

In alternative embodiments, the trajectory path 14 may further be determined by environmental aspects. For example, the impact of an effect of waves or water current on the watercraft 10.

In the presently described embodiment, the prediction algorithm uses a Kalman filter algorithm. Broadly, the Kalman filter algorithm is an estimator which relies on data derived from actual measurements to predict the trajectory path 14. Kalman filtering takes into account the current state of the watercraft 10 (via signals provided by the sensors), as well as uncertainties associated with the current state, to continuously adjust and refine the prediction of the trajectory path 14 of the watercraft 10. Specifically, the Kalman filter algorithm estimates at least one of: a magnitude and/or a rate of change of the steering of the watercraft 10 by the driver, and/or the application of acceleration or braking by the driver, which in part determines the predicted trajectory path 14. It is contemplated that, in an alternative embodiment, other estimators, such as extended or unscented Kalman filtering, etc., may be implemented to predict the trajectory path 14.

In an alternative embodiment, the prediction algorithm could be limited to projecting the watercraft 10 position based on information provided by a GNSS. For example, a first (past) GNSS position, as well as a second (current) GNSS position are received and the distance between these positions is determined. The time the watercraft 10 has taken to travel from the first position to the second position may also be measured. Using the distance travelled, and the time taken to travel this distance, the average speed of the watercraft 10 over the distance between the first and second GNSS positions may be calculated. Using the inherent handling characteristics of the watercraft 10 and the most recently calculated speed at which the watercraft 10 was travelling, the Kalman filter algorithm can estimate the speed in the near future. Based on the last received GNSS position, a probability can be associated with different likely future positions based on the Kalman filtering estimation and therefore the position which has the highest probability can be predicted. The prediction is over the distance to be travelled between the last received GNSS position and a future position corresponding to the next GNSS position to be received. The prediction algorithm may further improve the accuracy of the prediction of the trajectory path 14 with an increased sampling rate, and therefore the possible magnitude of variation of the estimated parameters will be smaller between estimations. Additionally, as the length of time over which the prediction takes place becomes smaller, the buildup of error between the actual and predicted position is reduced.

The method 100 continues, at step 106, with determining a trajectory position 16 of the watercraft 10. The trajectory position 16 corresponds to a point of interest along the predicted trajectory path 14. In this embodiment, the trajectory position 16 is selected based on a distance between the watercraft 10 and the secondary watercraft 12. Specifically, the trajectory position 16 is selected as a position with the shortest distance between the watercraft 10 and the position of the secondary watercraft 12, along the predicted trajectory path 14. In certain embodiments, the point of interest may, at least in part, depend on other factors, for example the steering angle of the watercraft 10. The trajectory path 14 is generally formed from a large number of discrete coordinates, which can be visually represented as being a continuous line for simplicity. In this embodiment, the trajectory position 16 is determined by comparing the coordinates which make up the predicted trajectory path 14 to the coordinates which make up the position of the secondary watercraft 12. It is appreciated that, in alternative embodiments, the point of interest may correspond to any position along the predicted trajectory path at which it is estimated that the steering angle and/or accelerator application will be such that the speed of the watercraft 10 will need be limited to avoid interaction with the secondary watercraft 12. It is to be understood that an interaction is an undesirable situation between the watercrafts 10, 12, for example, the watercrafts 10, 12 coming into close proximity with one another which may lead to undesirable outcomes for either of both of the watercrafts 10, 12.

The method 100 then continues, at step 108, with determining a separation distance 18 from the secondary watercraft 12 to the trajectory position 16 (as depicted in FIG. 2). The separation distance 18 is the distance between the secondary watercraft 12 and the trajectory position 16.

At step 110, the separation distance 18 is compared to a distance threshold. When the separation distance 18 of the watercraft 10 is outside (or greater than) the distance threshold, the speed of the watercraft 10 is not limited. If the separation distance 18 is within (or less than) the distance threshold, the method 100 continues, at step 112, with controlling the speed of the watercraft 10. It is appreciated that a larger distance threshold allows for a more progressive application of limiting the speed of the watercraft 10. It is further appreciated that, the smaller the distance threshold (that is, a shorter threshold distance from the secondary watercraft 12) the more improved the driving experience will be for the driver, as there is more freedom of control for the driver and less instances of a limitation being placed on speed, while the watercraft 10 is being operated in the presence of the secondary watercraft 12.

In certain embodiments, the distance threshold may be, in part, defined by physical characteristics of the watercraft 10. For example, the distance threshold may be determined, at least in part, by the aerodynamics and hydrodynamics of the watercraft 10. In certain embodiments, the distance threshold may be based, at least in part, on a speed of the watercraft 10 and the steering angle of the watercraft 10. For example, the distance threshold determined at a certain point relative to the secondary watercraft 12, based on the watercraft 10 steering angle being oriented straight towards the position of the secondary watercraft 12, while it is moving at a high speed (for example when the watercraft 10 is at full throttle), will be greater than, for example, the distance threshold of the watercraft 10, at this same point relative to the secondary watercraft 12, but for which the steering angle is away from the position of the secondary watercraft 12. In this example, the distance threshold would correspond to a distance at which the speed of the watercraft 10 should start to be limited such that the watercraft 10 would slow down due to friction of the environment to avoid interaction with the secondary watercraft 12. In certain embodiments, the distance threshold may be recursively determined. In alternative embodiments, the distance threshold may be input by the driver. In further alternative embodiments, the distance threshold may be predetermined. In further alternative embodiments, a table of distance thresholds corresponding to certain variables (e.g., steering angle relative to the position of the secondary watercraft 12) may be provided. It is further contemplated that, in some embodiments, safety margins may be added to the distance threshold to provide an additional buffer.

In certain embodiments, controlling the speed of the watercraft 10 involves limiting a speed of the watercraft 10. In this embodiment, limiting the speed of the watercraft 10 increases as the separation distance 18 decreases. In other words, if the subsequent trajectory paths 14 of the watercraft 10 continue to approach the position of the secondary watercraft 12 such that the separation distance 18 between the position of the secondary watercraft 12 and the trajectory position 16 decreases (i.e., approaches zero), the limitation on the speed of the watercraft 10 will increase. In contrast, if the subsequent trajectory paths 14 of the watercraft 10 move away from the position of the secondary watercraft 12, the limitation on the speed of the watercraft 10 will be reduced until the separation distance 18 is greater than the distance threshold, at which time there will be no limitation on the speed of the watercraft 10. It is contemplated that, in alternative embodiments, controlling the speed of the watercraft 10 involves increasing the speed of the watercraft 10.

In this embodiment, prior to controlling the speed of the watercraft 10, the method 100 involves step 114 of determining an arrival time of the watercraft 10 to the trajectory position 16. In other words, the arrival time is the time until the watercraft 10 reaches the trajectory position 16. In this embodiment, controlling the speed of the watercraft 10 is based, at least in part, on the arrival time. For example, as the arrival time approaches zero, the speed limitation is increased as there is less time until the watercraft 10 reaches the trajectory position 16. It is appreciated that the arrival time of the watercraft 10 is, in part, determined by the speed and/or acceleration of the watercraft 10. It is contemplated that, in alternative embodiments step 114 of determining the arrival time of the watercraft 10 may be omitted.

The method 100 is recursive and occurs at at least one sampling rate. In certain embodiments, the sampling rate may be between 10 Hz and 2000 Hz, for example at 100 Hz. Specifically, step 102 of receiving the input from the secondary watercraft 12, step 104 of determining the predicted trajectory path 14, step 106 of determining the trajectory position 16, step 108 of determining the separation distance 18, step 110 of comparing the separation distance 18 and the distance threshold, and step 114 of determining the arrival time to the trajectory position 16, occurs at the sampling rate. In certain embodiments, the sampling rate may increase as the separation distance 18 decreases steps 104 to 110, and step 114. In other words, the sampling rate will increase the closer the trajectory position 16 is to the position of the secondary watercraft 12. In some embodiments, steps 104 to 110, and step 114 may occur at the same sampling rate. In alternative embodiments, steps 104 to 110, and step 114 may occur at different sampling rates.

The method 100 uses the predicted trajectory path 14 and the trajectory position 16, along the trajectory path 14, to limit the speed of the watercraft 10 when the trajectory position 16 is within the distance threshold to the position of the secondary watercraft 12. The method 100 provides speed limitation based on the intent of the driver of the watercraft 10 by taking into account the current state of the watercraft 10, via signals provided by sensors, and a prediction algorithm that implements an estimator, such as a Kalman filter algorithm. As steps 104 to 110, and step 114, corresponding to determining the trajectory path 14, the trajectory position 16, the separation distance 18, whether the separation distance 18 is within the distance threshold, and determining the arrival time, are recursive, the limitation imposed on the speed of the watercraft 10 are continually re-assessed to provide the driver with a smoother operation of the watercraft 10 during speed limitation. Furthermore, as the trajectory position 16 corresponds to the shortest distance between the watercraft 10 and the position of the secondary watercraft 12 in this embodiment, taken along the trajectory path 14, the speed of the watercraft 10 is limited to avoid interaction with the secondary watercraft 12.

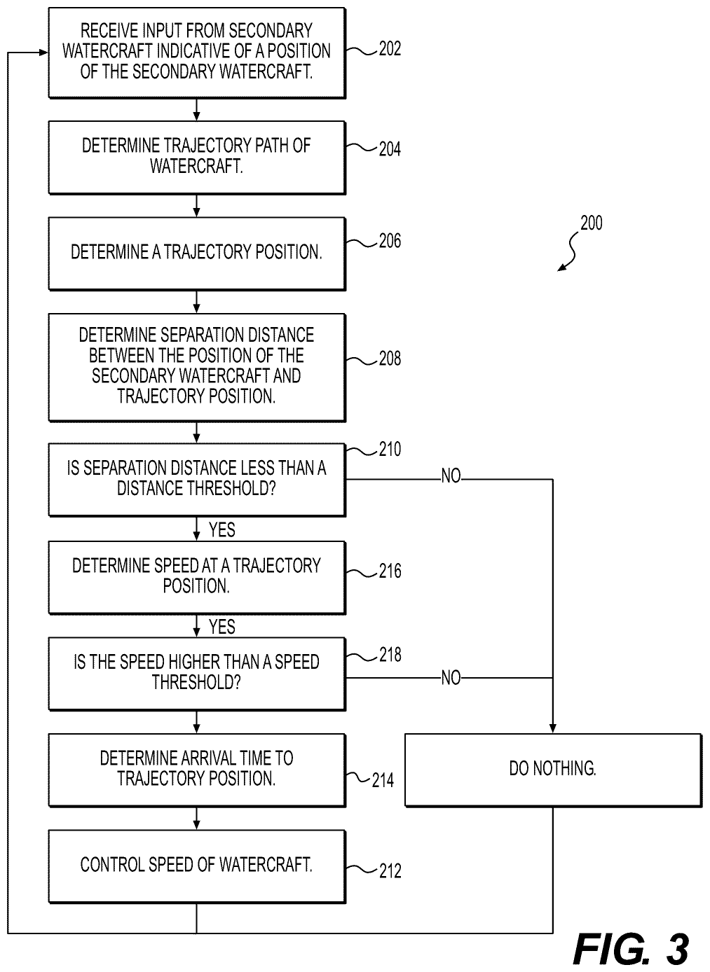

FIG. 3 illustrates a flow chart depicting an alternative method 200 of controlling the watercraft 10. This embodiment includes step 202 of receiving the input from the secondary watercraft 12, step 204 of determining the trajectory path 14 of the watercraft 10, step 206 of determining the trajectory position 16 of the watercraft 10, step 208 of determining the separation distance 10, step 210 of determining if the separation distance is within (or less than) the distance threshold, and step 214 of determining the arrival time. In this embodiment, steps 202 to 210, and step 214 are equivalent to steps 102 to 110, and step 114 as previously described with regards to the method 100 and thus, will not be described in further detail.

In this embodiment, if the separation distance 18 is less than the distance threshold, the method 200 continues, at step 216, with determining a trajectory speed of the watercraft 10 at the trajectory position 16. The trajectory speed of the watercraft 10 is determined, at least in part, by the current state of the watercraft 10, such as current orientation, speed, and/or position, and determined by a prediction algorithm.

As previously described, the current state of the watercraft 10 may be obtained by the sensors positioned on the watercraft 10 and communicatively connected to the processor, such that the processor receives signals from the sensors. In some embodiments, the sensors may include an accelerometer, a gyroscope, a magnetometer, and a GNSS. However, it is appreciated that other sensors may be implemented and communicatively connected to the processor to provide signals regarding the current state of the watercraft 10.

In this embodiment, the prediction algorithm uses a Kalman filter algorithm, which has been previously described relative to the predicted trajectory path 14. A similar application is used to predict the speed of the watercraft 10 at the trajectory position 16, in that the Kalman filter algorithm takes into account the current state of the watercraft 10 (via signals provided by the sensors), as well as uncertainties associated with the current state, to continuously adjust and refine its prediction of the speed of the watercraft 10 at the trajectory position 16. As previously described, the Kalman filter algorithm estimates at least one of: a future magnitude and/or a rate of change of the steering angle of the watercraft 10 by the driver, and/or the future application of acceleration or braking by the driver, which determines, at least in part, the predicted trajectory path 14, as well as the trajectory speed. It is contemplated that, in alternative embodiments, other estimators, such as an extended or unscented Kalman filtering, etc., may be implemented to predict the speed at the trajectory position 16.

Although the prediction algorithms associated with the predicting the trajectory path 14 and predicting the speed at the trajectory position 16 both apply Kalman filter algorithms, it is appreciated that, in alternative embodiments, predicting the trajectory path 14 may implement a different prediction algorithm and/or estimator than that of predicting the speed at the trajectory position 16.

The method 200 includes step 218 of determining if the speed at the trajectory position 16 is higher than a speed threshold. If the speed at the trajectory position 16 of the watercraft 10 is greater than the speed threshold, the method 200 continues with step 212 of controlling the speed of the watercraft 10. In this embodiment, the speed threshold is based, at least in part, on a speed limit. In some instances, the speed limit (and therefore the speed threshold) may be specified by the driver of the watercraft 10, for example the speed limit may be selected based on the driver's comfort. In other instances, the speed threshold may be predefined, for example the speed limit may be selected to mitigate adverse outcomes.

In this embodiment, controlling the speed of the watercraft 10 involves limiting the speed of the watercraft 10 such that, when the watercraft 10 reaches the location of the trajectory position 16 the speed of the watercraft 10 is substantially within the speed threshold.

The method 200 is recursive and occurs at occurs at at least one sampling rate. In certain embodiments, the sampling rate may be between 10 Hz to 2000 Hz, for example at 100 Hz. Specifically, step 202 of receiving the input from the secondary watercraft 12, step 204 of determining the predicted trajectory path 14, step 206 of determining the trajectory position 16, step 208 of determining the separation distance 18, step 210 of comparing the separation distance 18 and the distance threshold, step 214 of determining the arrival time to the trajectory position 16, step 216 of determining the speed at the trajectory position 16, and step 218 of comparing the speed at the trajectory position 16 and the speed threshold occurs at the sampling rate. In certain embodiments, the sampling rate may increase as the separation distance 18 decreases. In other words, the sampling rate will increase the closer the trajectory position 16 is to the border 12. In some embodiments, steps 204 to 210, 214 and step 216, may occur at the same sampling rate. In alternative embodiments, steps 202, 204 to 210, 214 and step 216, may occur at different sampling rates.

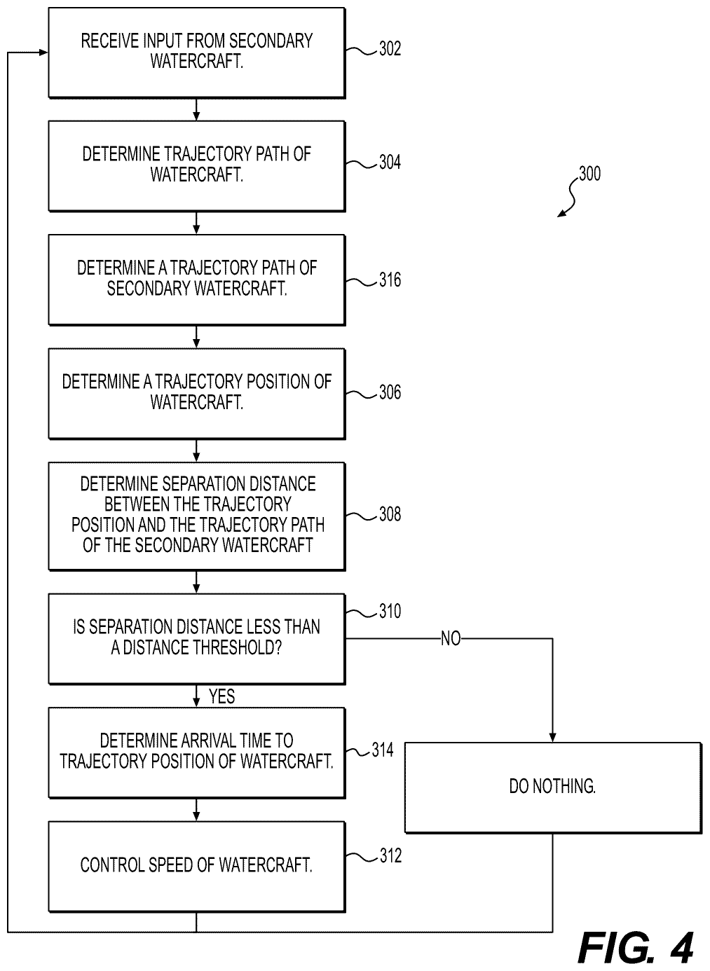

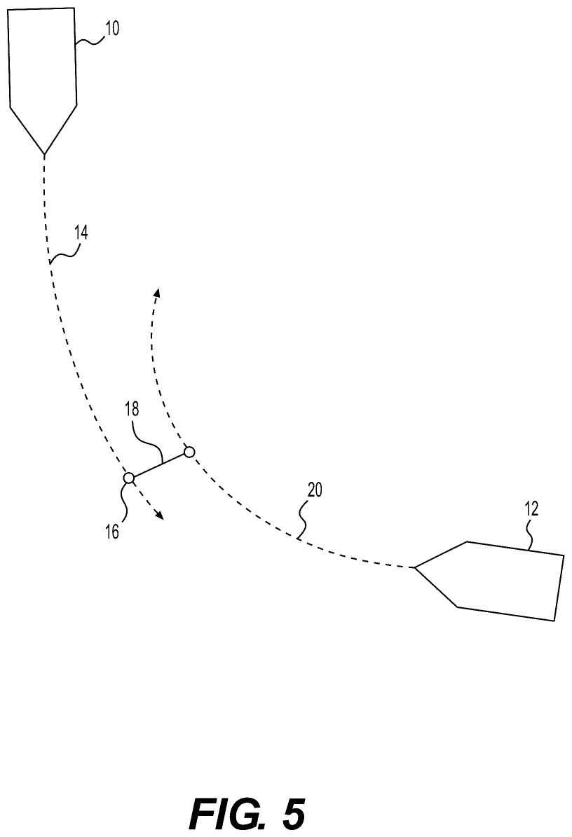

With reference to FIGS. 4 and 5, an alternative method 300 of controlling the watercraft 10 will now be described. Similar to the method 100, 200 previously described the method 300 is executed on a processor which is part of the watercraft 10. The processor is configured to receive information regarding the watercraft 10, such as position, orientation, and/or speed of the watercraft 10, as well as information regarding the secondary watercraft 12, which will be described in further detail below.

The method 300 begins, at step 302, with receiving the input from the secondary watercraft 12. In this embodiment, receiving the input from the secondary watercraft 12 includes receiving at least one signal indicative of at least one of: a current orientation of the secondary off-road vehicle, a speed of the secondary off-road vehicle, an acceleration of the secondary off-road vehicle, a steering angle of the secondary off-road vehicle, a user input of the secondary off-road vehicle, and a position of the secondary off-road vehicle. It is contemplated that, in some embodiments, the watercraft 10 could include a camera to detect behavior (i.e., speed, acceleration, orientation, and/or position) of the secondary watercraft 12, and the input could be received from the camera of the watercraft 10. It is further contemplated that, in alternative embodiments, the respective watercrafts 10, 12 are configured to communicate wirelessly via C-V2X communication and receiving the input from the secondary watercraft 12 involves receiving a signal compatible with C-V2X communication.

The method 300 continues at step 304, with determining the predicted trajectory path 14 of the watercraft 10. In this embodiment, step 304 is equivalent to step 104, 204 as previously described, and therefore will not be described in further detail.

In this embodiment, the method continues, at step 316, with determining a predicted trajectory path 20 of the secondary watercraft 12. As previously described, with respect to predicting the trajectory path 16 of the watercraft 10, determining the predicted trajectory 20 of the secondary watercraft 12 is, at least in part, determined by the signal received by the watercraft 10 at step 302, as well as determined by a prediction algorithm. The prediction algorithm of the method 100, 200 described above is applied in the present embodiment and therefore will not be described in further detail. In some embodiments, determining the predicted trajectory path 20 of the secondary watercraft 12 is performed by the processor of the watercraft 10 based on signals received from the secondary watercraft 12. In certain instances, these signals may include at least one of: an acceleration, a steering angle, a speed, a position, and/or a user input of the secondary watercraft 12. In other embodiments, a processor of the secondary watercraft 12 determines the predicted trajectory path 20 of the secondary watercraft 12. In this embodiment, the signal received by the watercraft 10 from the secondary watercraft 12 includes, at least, the predicted trajectory path 20 of the secondary watercraft 12.

In certain embodiments, the trajectory path 20 is further predicted, at least in part, by characteristics of the secondary watercraft 12. Specifically, characteristics related to the handling of the secondary watercraft 12 could include but are not limited to speed and/or acceleration. For example, the prediction could take into consideration: how tight the secondary watercraft 12 can turn, how much negative acceleration the secondary watercraft 12 may experience (if there is no accelerator input), how much speed the secondary watercraft 12 can gain over a distance during maximum acceleration, how much acceleration the secondary watercraft 12 may experience when turning at certain angles, etc. In some instances, these characteristics may be included in the input received by the watercraft 10.

In alternative embodiments, the trajectory path 20 may further be determined by environmental aspects. For example, the environmental aspects could include the impact of an effect of waves or water current on the secondary watercraft 12.

In this embodiment, the method 300 continues, at step 306, with determining a trajectory position 16 of the watercraft 10. The trajectory position 16 corresponds to a point of interest along the predicted trajectory path 14. In this embodiment, the trajectory position 16 is selected based on a distance between the watercraft 10 and the secondary watercraft 12. Specifically, the trajectory position 16 is selected as a position with the shortest distance between the watercraft 10 and the predicted trajectory path 20 of the secondary watercraft 12, along the predicted trajectory path 14. In certain embodiments, the point of interest may, at least in part, depend on other factors, for example the steering angle of the watercraft 10. Each of the trajectory paths 14, 20 is generally formed from a large number of discrete coordinates, which can be visually represented as being continuous lines for simplicity. In this embodiment, the trajectory position 16 is determined by comparing the coordinates which make up the predicted trajectory path 14 of the watercraft 10 to the coordinates which make up the predicted trajectory path 20 of the secondary watercraft 12. It is appreciated that, in alternative embodiments, the point of interest may correspond to any position along the predicted trajectory path 14 at which it is estimated that the steering angle and/or accelerator application will be such that the speed of the watercraft 10 will need be limited to avoid interaction with the secondary watercraft 12.

The method 300 then continues, at step 308, with determining a separation distance 18 from the predicted trajectory path 20 of the secondary watercraft 12 to the trajectory position 16 (depicted in FIG. 5). The separation distance 18 is the distance between the trajectory position 16 and the predicted trajectory path 20 of the secondary watercraft 12.

At step 310, the separation distance 18 is compared to a distance threshold. In this embodiment, step 310 is equivalent to step 110, 210 as previously described, and therefore will not be described in further detail.

In this embodiment, the method 300 continues, at step 314, with determining an arrival time of the watercraft 10 to the trajectory position 16. It is appreciated that step 314 is similar to step 114, 214 and will not be described in further detail. It is contemplated that, in alternative embodiments, step 314 of determining the arrival time of the watercraft 10 may be omitted.

The method 330 then continues, at step 312, with controlling the speed of the watercraft 10, generally by limiting the speed of the watercraft 10. In this embodiment, step 310 is similar to step 110 as previously described, and therefore will not be described in further detail.

The method 300 is recursive and occurs at occurs at at least one sampling rate. In certain embodiments, the sampling rate may be between 10 Hz and 2000 Hz, for example at 100 Hz. Specifically, step 302 of receiving the input from the secondary watercraft 12, step 304 of determining the predicted trajectory path 14, step 316 of determining the predicted trajectory path 20 of the secondary watercraft 12, step 306 of determining the trajectory position 16, step 308 of determining the separation distance 18, step 110 of comparing the separation distance 18 and the distance threshold, and step 314 of determining the arrival time to the trajectory position 16, occurs at the sampling rate. In certain embodiments, the sampling rate may increase as the separation distance 18 decreases steps 304 to 310, step 314, and step 316. In other words, the sampling rate will increase the closer the trajectory position 16 is to the predicted trajectory path 20 of the secondary watercraft 12. In some embodiments, 304 to 310, step 314, and step 316 may occur at the same sampling rate. In alternative embodiments, steps 304 to 310, step 314, and step 316 may occur at different sampling rates.

In the embodiments described, controlling the speed of the watercraft 10 (in steps 112, 212, 312) would result in limiting the speed of a jet pump or an outboard engine of the watercraft 10. For example, the processor is communicatively connected to the jet pump or the outboard engine such that the processor transmits instructions to the engine control unit to limit the speed of the watercraft 10. For example, when the driver actuates the throttle, the processor transmits a torque request which would be limited as a result of the speed limitation. Alternatively, in other embodiments, the processor may activate an alert for the driver that the watercraft 10 is approaching the secondary watercraft 12 and that the driver should limit the speed. The alert may be a visual indication, for example displayed on a display of the watercraft 10, or an audible indication. In further embodiments, the processor may, both, cause transmission of the signal to the jet pump or outboard engine to adjust speed and send the alert to the driver indicating the watercraft 10 is approaching the secondary watercraft 12 and that the speed will be limited.

In some embodiments, methods 100, 200, 300 may further include determining a probability of interaction. The probability of interaction is determined, at least in part, by at least one of: the separation distance 18, the arrival time, and an accuracy of the sensors of the watercraft 10. The accuracy of the sensors may vary due to environmental factors and be reduced by the influence of electromagnetic interference generating noise in the signals output by said sensors. Additionally, the accuracy of a GNSS is subject to many factors, such as satellite positioning and atmospheric conditions.

As previously described, in some embodiments, the method 100, 200, 300 may optionally include receiving a driver defined speed limit when the separation distance is below the distance threshold. The method 100, 200, 300 may optionally include receiving the driver defined distance threshold and/or speed threshold (of the method 200) from the driver via an input system, such as a computer system of the watercraft 10. In alternative embodiments, the driver may use an application on a mobile device, such as a cell phone, which communicates with the processor of the watercraft 10.

Modifications and improvements to the above-described embodiments of the present technology may become apparent to those skilled in the art. The foregoing description is intended to be exemplary rather than limiting.

What is claimed:

1. A method for controlling an off-road vehicle relative to a secondary off-road vehicle, the method being executed by a processor of the vehicle, the method comprising:
receiving an input from the secondary off-road vehicle, the input being indicative of a position of the secondary off-road vehicle;
determining a predicted trajectory path of the vehicle;
determining a trajectory position of the vehicle, the trajectory position corresponding to a point of interest on the predicted trajectory path selected based on at least a distance between the vehicle and the position of the secondary off-road vehicle;
determining a separation distance between the trajectory position of the vehicle and the position of the secondary off-road vehicle; and
in response to the separation distance being less than a distance threshold, controlling a speed of the vehicle.

2. The method of claim 1, further comprising determining an arrival time until the vehicle reaches the trajectory position, and wherein controlling the speed of the vehicle is based, at least in part, on the arrival time.

3. The method of claim 2, wherein:
controlling the speed of the vehicle comprises limiting a speed of the vehicle, and
in response to a decrease of the arrival time, increasing limitation of the speed of the vehicle.

4. The method of claim 1, wherein receiving the input of the secondary off-road vehicle comprises receiving a signal compatible with C-V2X communication.

5. The method of claim 1, wherein the vehicle further comprises a camera and wherein receiving the input of the secondary off-road vehicle comprises receiving an input from the camera.

6. The method of claim 1, wherein receiving the input of the secondary off-road vehicle further comprises receiving at least one of: a speed of the secondary off-road vehicle, an acceleration of the secondary off-road vehicle, an orientation of the secondary off-road vehicle, and a steering angle of the secondary off-road vehicle.

7. The method of claim 1, wherein:
determining the predicted trajectory path, determining the trajectory position, and determining the separation distance are recursive and occurs at at least one sampling rate.

8. The method of claim 1, further comprising:
determining a trajectory speed of the vehicle at the trajectory position; and
in response to the trajectory speed being greater than a speed threshold, controlling the speed of the vehicle.

9. The method of claim 8, further comprising:
receiving a signal from at least one sensor, the vehicle including the at least one sensor for detecting at least one of: a current orientation of the vehicle, the speed of the vehicle, an acceleration of the vehicle, a steering angle of the vehicle, a user input, and a current position of the vehicle; and
wherein determining the trajectory speed of the vehicle comprises:
using a prediction algorithm and the signal from the at least one sensor to determine the trajectory speed.

10. The method of claim 9, wherein receiving the signal from the at least one sensor comprises receiving a signal from at least one of: an accelerometer, a gyroscope, a magnetometer, a steering angle sensor, a user input sensor, and a global navigation satellite system.

11. The method of claim 1, further comprising:
receiving a signal from at least one sensor, the vehicle including the at least one sensor for detecting at least one of: a current orientation of the vehicle, the speed of the vehicle, an acceleration of the vehicle, a steering angle, a user input, and a current position of the vehicle; and
wherein determining the predicted trajectory path of the vehicle comprises:
using a prediction algorithm and the signal from the at least one sensor.

12. The method of claim 11, wherein determining the predicted trajectory path of the vehicle comprises determining at least one of: a magnitude of steering the vehicle, a rate of change of steering the vehicle, a magnitude of throttle, a rate of change of throttle, a magnitude of braking, and a rate of change of braking.

13. The method of claim 11, wherein receiving the signal from the at least one sensor comprises receiving the signal from at least one of: an accelerometer, a gyroscope, a magnetometer, a steering angle sensor, a user input sensor, and a global positioning system.

14. The method of claim 11, further comprising:
determining an arrival time until the vehicle reaches the trajectory position; and
determining a probability of interaction, the probability of interaction being determined at least in part by the separation distance and an accuracy of the at least one sensor; and wherein:
controlling the speed of the vehicle is based, at least in part, on the arrival time and the probability of interaction.

15. The method of claim 1, further comprising triggering at least one of a visual and an audible alert to a driver of the vehicle to indicate that the vehicle speed is being controlled.

16. A method for controlling an off-road vehicle relative to a secondary off-road vehicle, the method being executed by a processor of the vehicle, the method comprising:
receiving an input from the secondary off-road vehicle;
determining a predicted trajectory path of the vehicle;
determining a secondary off-road vehicle predicted trajectory path;
determining a trajectory position of the vehicle, the trajectory position corresponding to a point of interest on the predicted trajectory path selected based on a distance between the predicted trajectory path and the secondary off-road vehicle predicted trajectory path;
determining a separation distance between the trajectory position and the secondary off-road vehicle predicted trajectory path; and
in response to the separation distance being less than a distance threshold, controlling a speed of the vehicle.

17. The method of claim 16, wherein receiving the input from the secondary off-road vehicle comprises:
receiving at least one signal indicative of at least one of: a current orientation of the secondary off-road vehicle, a speed of the secondary off-road vehicle, an acceleration of the secondary off-road vehicle, a steering angle of the secondary off-road vehicle, a user input of the secondary off-road vehicle, and a position of the secondary off-road vehicle.

18. The method of claim 16, wherein determining the secondary off-road vehicle predicted trajectory path comprises using a prediction algorithm and the at least one signal.

19. The method of claim 16, further comprising determining an arrival time until the vehicle reaches the trajectory position, and wherein controlling the speed of the vehicle is based, at least in part, on the arrival time.

20. The method of claim 19, wherein controlling the speed of the vehicle comprises limiting a speed of the vehicle, and as the arrival time approaches zero, increasing limitation of the speed of the vehicle.
